(19) United States
(12) Patent Application Publication
(10) Pub. No.: US 2017/0072936 A1
(43) Pub. Date: Mar. 16, 2017

(54) CONTROL SYSTEM FOR HYBRID VEHICLE

(71) Applicant: TOYOTA JIDOSHA KABUSHIKI KAISHA, Toyota-shi (JP)

(72) Inventor: Tomokazu INAGAWA, Toyota-shi (JP)

(73) Assignee: TOYOTA JIDOSHA KABUSHIKI KAISHA, Toyota-shi (JP)

(21) Appl. No.: 15/235,617

(22) Filed: Aug. 12, 2016

(30) Foreign Application Priority Data
Sep. 11, 2015 (JP) 2015-179282

(51) Int. Cl. B60W 20/11; F16H 3/66; B60W 10/08; F16F 15/134; B60W 10/06; F16H 37/04; F16H 3/72

(52) U.S. Cl. CPC B60W 20/11; F16H 37/046; F16H 3/66; F16H 3/727; F16F 15/134; B60W 10/06; B60W 10/08; B60W 2710/083; B60W 2710/0666

(57) ABSTRACT

A control system for a hybrid vehicle is provided to suppress noise generated by an application of excessive torque to a torsional damper. A controller predicts that a limit torque is applied to the input member. If an application of the limit torque to the input member is expected, the controller restricts an output torque of an engine while adjusting an output torque of the motor to compensate a reduction in a drive force resulting from a restriction of the engine torque.

### CROSS REFERENCE TO RELATED APPLICATIONS

The present application claims the benefit of priority to Japanese Patent Application No. 2015-179282 filed on Sep. 11, 2015 with the Japanese Patent Office, the entire contents of which are incorporated herein by reference in its entirety.

### BACKGROUND

Field of the Disclosure

Embodiments of the present application relates to the art of a control system for a hybrid vehicle having a torsional damper for absorbing torque pulse, and a motor disposed between the torsional damper and drive wheels.

Discussion of the Related Art

JP-A-2013-233910 describes one example of a control device of a hybrid vehicle in which a torsional damper is connected to an output shaft of an engine, and in which a motor is connected to an output shaft of the torsional damper. In the hybrid vehicle taught by JP-A-2013-233910, cranking of the engine is executed by an output torque of the motor. According to the teachings of JP-A-2013-233910, the torsional damper includes an input member connected to the output shaft of the engine, an output member allowed to rotate relatively to the input member, and an elastic member that elastically transmits torque from the input member to the output member while being compressed by a relative rotation between the input member and the output member. In order to suppress vibrations generated during cranking of the engine, an output torque of the motor is corrected by a correction torque of a phase opposite to the phase of a twist angle of the torsional damper.

In the torsional damper taught by JP-A-2013-233910, the input member and the output member come into contact with each other upon exceedance of phase difference therebetween to prevent an excessive compression of the elastic member. However, such contact between the input member and the output member may generate a noise if a large torque is applied from the engine. In addition, such limitation of the relative rotation between the input member and the output member may limit a vibration damping performance of the torsional damper.

A dynamic damper for suppressing torque pulse by an oscillation of a mass along a raceway surface formed in a rotary member is also known in the art. In the dynamic damper of this kind, noise may also be generated by a collision of the mass against the raceway surface, and a vibration damping performance is also limited within a width of the raceway surface.

### SUMMARY

Aspects of the present application have been conceived noting the foregoing technical problems, and it is therefore an object of the present application is to provide a control system for a hybrid vehicle configured to suppress noise generated by an application of excessive torque to a torsional damper.

The control system according to the embodiment is applied to a hybrid vehicle comprising: an engine; a torsional damper in which an input member and a relative member are moved relatively to each other in a rotational direction by a pulsation of a torque of the engine applied to the input member; and a motor that is disposed on a power train between the torsional damper and drive wheels. In order to achieve the above-explained objective, the control system is provided with a controller that is configured to predict that a limit torque by which a relative movement of the relative member to the input member is increased to be equal to or greater than a first predetermined value is applied to the input member, and to restrict the torque of the engine to be lower than the limit torque while adjusting an output torque of the motor to compensate a reduction in a drive force resulting from a restriction of the torque of the engine, in a case that an application of the limit torque to the input member is expected.

In a non-limiting embodiment, a map determining the relative movement with respect to the torque applied to the input member is installed into the controller. In addition, the controller is further configured to estimate the relative movement with respect to the torque applied to the input member with reference to the map.

In a non-limiting embodiment, the controller is further configured to obtain an actual torque applied to the input member and an actual relative movement of the relative member of a case in which the actual torque is applied to the input member, and to update the map based on the actual torque and the actual relative movement.

In a non-limiting embodiment, the controller is further configured to: calculate a difference between the actual torque and a torque applied to the input member determined by the map, and to update the map by adding the calculated difference to each value of the torque applied to the input member determined by the map.

In a non-limiting embodiment, the controller is further configured to calculate a first coefficient of a function defining a relation between the torque and the relative movement based on the actual torque and the actual relative movement, and to update each value of the torque applied to the input member determined in the map by multiplying each value of the relative movement determined by the map individually by the first coefficient.

In a non-limiting embodiment, the controller is further configured to: calculate a deviation from a reference value of the relative movement in which the torque is not applied to the input member to the actual relative movement; calculate a second coefficient of a function defining a relation between the torque and the relative movement based on the actual torque and the actual relative movement; and update each value of the torque applied to the input member determined by the map, by multiplying each value of the relative movement determined by the map individually by the second coefficient.

In a non-limiting embodiment, the controller is further configured to update the map in a case that the actual relative movement is greater than a second predetermined value.

In a non-limiting embodiment, the controller is further configured to restrict the torque of the engine in such a manner that the relative movement determined by the map is reduced to be smaller than the first predetermined value.

In a non-limiting embodiment, the relative member includes an output member that is connected to the drive wheels while being allowed to rotate relatively to the input member, and the torsional damper comprises the input member, the output member, and an elastic member that is elastically deformed by a relative rotation between the input member and the output member. In addition, the relative movement includes a phase difference between the input member and the output member.

In a non-limiting embodiment, the input member comprises a holding chamber having a predetermined length in a circumferential direction, and the relative member includes a rolling mass that is held in the holding chamber while being allowed to be oscillated therein by pulsation of the torque applied to the input member. In addition, the relative rotation includes at least one of an amplitude of oscillation of the rolling mass and a phase of the rolling mass.

Thus, according to the embodiment, output torque of the engine is restricted in a case that a relative movement of the relative member to the input member is increased to be greater than the first predetermined value by an application of excessive torque to the input member. For this reason, the relative movement between the relative member and the input member can be restricted to suppress noise resulting from collision of the relative member with the input member while ensuring vibration damping performance. Even if the output torque of the engine is restricted, a required drive force can be ensured by adjusting output torque of the motor disposed on downstream side of the torsional damper.

In addition, the map determining a relation between the input torque to the input member and the relative movement between the input member and the relative member is updated based on the actual input torque to the input member and the resultant actual relative movement. That is, the map is updated taking account of time degradation of the elastic member etc. so that collision of the relative member with the input member can be prevented certainly while ensuring vibration damping performance.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a flowchart showing a control example according to the embodiment;

FIG. 2 is a schematic illustration showing an example of a structure of the hybrid vehicle to which the control system according to the embodiment is applied;

FIG. 3 is a schematic illustration showing a structure of a spring damper according to the embodiment;

FIG. 4 is one example of a map used in the control according to the embodiment;

FIG. 5 is a graph indicating a relation between the engine torque and the torsion angle of the damper;

FIG. 6 is a time chart indicating temporal changes in the engine torque and the torsion angle of the damper;

FIG. 7 is a flowchart showing a procedure to update the map;

FIG. 8 is a front view showing a structure of the dynamic damper according to the embodiment;

FIG. 9 is a schematic illustration showing a structure of a sensor for detecting amplitude of oscillation of a mass of the dynamic damper; and

FIG. 10 is a cross-sectional view showing a structure of the torsional damper in which the spring damper is connected to the dynamic damper.

### DETAILED DESCRIPTION OF THE PREFERRED EMBODIMENT(S)

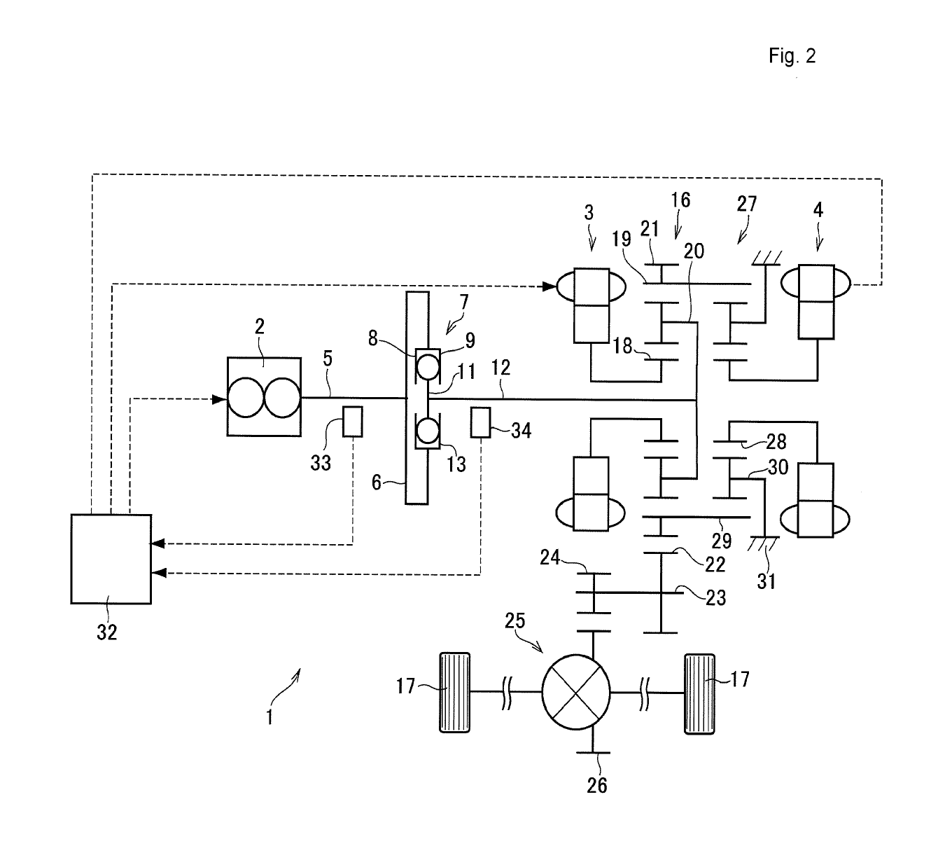

Preferred embodiments of the present application will now be explained with reference to the accompanying drawings. Referring now to FIG. 2, there is shown a structure of the hybrid vehicle to which the control system according to the embodiment is applied. A prime mover of a hybrid vehicle (as will be simply called the “vehicle” hereinafter) 1 includes an engine 2, a first motor 3, and a second motor 4. A spring damper 7 as a torsional damper is connected to an output shaft 5 of the engine 2 through a flywheel 6. The spring damper 7 is adapted to absorb torque pulses arising from combustion in the engine 2.

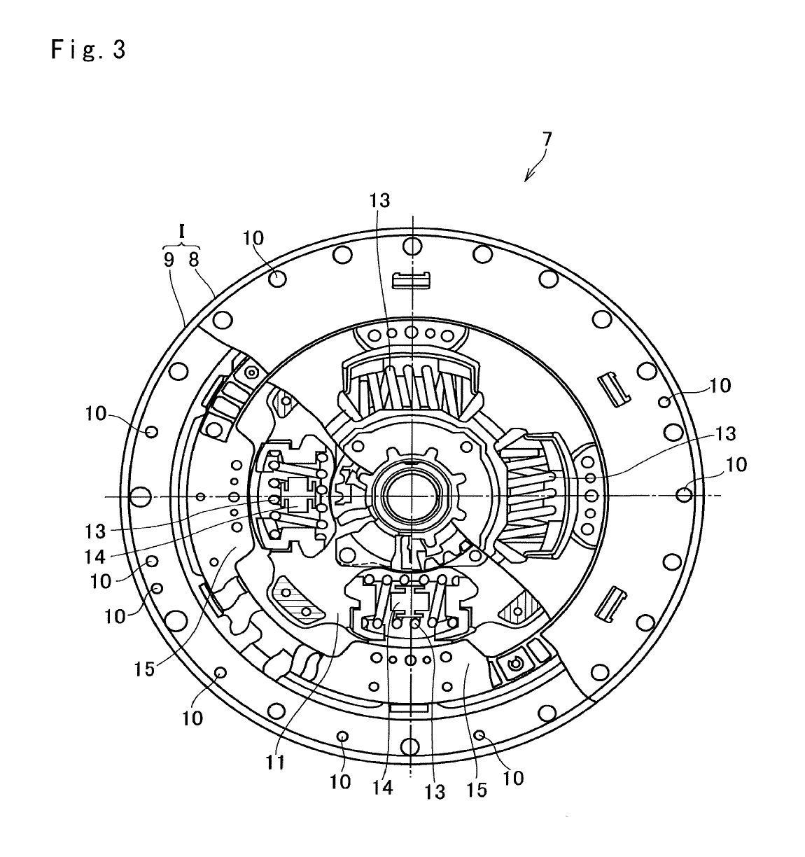

A structure of the spring damper 7 is shown in FIG. 3 in more detail. As depicted in FIG. 3, the spring damper 7 comprises an annular front plate 8 fixed to the flywheel 6 at an outer circumference, and an annular rear plate 9 opposed to the front plate 8 at the opposite side of the flywheel 6. The front plate 8 and the rear plate 9 have bulges around a rotational center expanded away from each other so that a housing space is formed therebetween, and the front plate 8 and the rear plate 9 are fixed to each other at an outer circumference by rivets 10 to form an input member I.

An annular center plate 11 is held in the housing space formed between the front plate 8 and the rear plate 9 in such a manner as to rotate relatively to the input member I while being connected to an output shaft 12 of the spring damper 7 to serve as an output member or a relative member of the embodiment.

Each of the front plate 8, the rear plate 9 and the center plate 11 has the same number of spring windows having same widths spaced at predetermined intervals in a circumferential direction, and the windows of those plates are overlapped with one another to form spring holders individually holding a coil spring 13 therein. A column-shaped cushion 14 that is shorter than the coil spring 13 is individually arranged in each of the coil spring 13 at a width center of the coil spring 13. Accordingly, the coil spring 13 and the cushion 14 serves as the elastic member of the embodiment. In the embodiment shown in FIG. 3, specifically, four spring holders are formed on the assembly of the plates 8, 9 and 11, and the coil spring 13 and the cushion 14 are individually held in each of the spring holder.

An outer diameter of the coil spring 13 is larger than a clearance between the front plate 8 and the rear plate 9 in the housing space to protrude from the spring holder. In the spring holder, therefore, the coil spring 13 is compressed by one of width end surfaces of the windows of the front plate 8 and the rear plate 9 and other width end surface of the window of the center plate 11 when the input member I and the center plate 11 are rotated relatively to each other. In this situation, when the input member I and the center plate 11 are further rotated relatively to each other, the cushion 14 is compressed by one of the width end surfaces of the windows of the front plate 8 and the rear plate 9 and the other width end surface of the window of the center plate 11.

In order to prevent the coil spring 13 and the cushion 14 from being compressed excessively, a stopper plate 15 is arranged in the housing space while being connected to at least one of the front plate 8 and the rear plate 9. An inner circumferential edge of the stopper plate 15 is partially protruded radially inwardly toward each of the spring holder to restrict an amount of relative rotation between the input member I and the center plate 11. Whereas, the center plate 11 also has protrusions protruding radially outwardly toward each interval between protrusions of the stopper plate 15. In the spring damper 7, therefore, one of width ends of each of the protrusion of the center plate 11 comes into contact with one of width ends of each of the protrusion of the stopper plate 15 when an amount of relative rotation between the input member I and the center plate 11 reaches a predetermined amount.

Turning back to FIG. 2, a single-pinion first planetary gear unit 16 is disposed on the downstream side of the spring damper 7 to distribute torque of the engine 2 to the first motor 3 and to the drive wheels 17. Specifically, the first planetary gear unit 16 comprises a first sun gear 18 connected to the first motor 3, a first ring gear 19 arranged concentrically with the first sun gear 18 while being connected to the drive wheels 17, a plurality of pinion gears interposed between the first sun gear 18 and the first ring gear 19, and a first carrier 20 supporting the pinion gears in a rotatable and revolvable manner while being connected to the output shaft 12 of the spring damper 7. For example, a conventional permanent magnet synchronous motor may be used as the first motor 3, and an output torque and a speed of the first motor 3 may be controlled separately. Specifically, the first motor 3 is adapted not only to increase a rotational speed of the first sun gear 18 by an output torque thereof, but also to generate an electric power by generating a torque while the first sun gear 18 is rotated by another torque.

An output gear 12 as an external gear is formed integrally with the first ring gear 19. A countershaft 23 extends in parallel with the output shaft 5 of the engine 2 connected to the output shaft 12 of the spring damper 7, and a driven gear 22 is fitted onto one end of the countershaft 23 to be meshed with the output gear 21. A drive gear 24 that is diametrically smaller than the driven gear 22 is fitted onto the other end of the countershaft 23 to be meshed with a ring gear 26 of a differential gear unit 25 that distributes drive force to the drive wheels 17.

In the vehicle 1, during delivering an output torque of the engine 2 to the drive wheels 17, an output torque of the first motor 3 is controlled in such a manner that the first sun gear 18 of the first planetary gear unit 16 serves as a reaction element, and a speed of the first motor 3 is controlled in such a manner that a speed of the engine 2 is adjusted to a target speed. In this situation, the first motor 3 is allowed to serve as a generator by controlling an output torque thereof in such a manner as to reduce a rotational speed of the first sun gear 18. Consequently, a kinetic power applied to the first planetary gear unit 16 is partially converted into an electric power by the first motor 3. In order to compensate the power thus converted into the electric power, the vehicle 1 is further provided with a second motor 4 that is also a permanent magnet synchronous motor.

During adjusting a sapped of the engine 2 to the target speed by controlling a speed of the first motor 3 while generating torque in a direction to increase a rotational speed of the first sun gear 18, an output power of the first motor 3 is applied to the first ring gear 19 in addition to an output power of the engine 2. In this situation, the output power of the first motor 3 may be converted into an electric power by operating the second motor 4 as a generator. Thus, in the vehicle 1, any one of the first motor 3 and the second motor 4 is operated to generate a drive force.

To this end, the first motor 3 and the second motor 4 are individually connected to a battery (not shown), and also connected to each other to directly exchange electricity therebetween without passing through the battery.

An output torque of the second motor 4 is delivered to the powertrain though a single-pinion second planetary gear unit 27 that is disposed on the downstream side of the first planetary gear unit 16. Specifically, the second planetary gear unit 27 comprises a second sun gear 28 connected to the second motor 4, a second ring gear 29 integrated with the first ring gear 19, a plurality of pinion gears interposed between the second sun gear 28 and the second ring gear 29, and a second carrier supporting the pinion gears in a rotatable and revolvable manner that is connected to a stationary member 31 such as a casing. Specifically, the output torque of the second motor 4 is delivered to the second ring gear 29 while being reversed and changed in accordance with a gear ratio of the second planetary gear unit 27.

In order to control the engine 2, the first motor 3 and the second motor 4, the vehicle 1 is further provided with an electronic control unit (to be abbreviated as the “ECU” hereinafter) 32 as a controller. Specifically, the ECU 32 is configured to control the engine 2 and the motors 3 and 4 based on preinstalled data such as maps and formulas, and incident signals from first speed sensor 33 that detects a rotational speed of the output shaft 5 of the engine 2, a second speed sensor 34 that detects a rotational speed of the output shaft 12 of the spring damper 7, a depression sensor that detects a depression of an accelerator pedal (not shown) and so on. The ECU 32 may be further configured to control other devices such as an electric oil pump (not shown) and so on. Optionally, the engine 2 and the motors 3 and 4 may also be controlled individually by different control units.

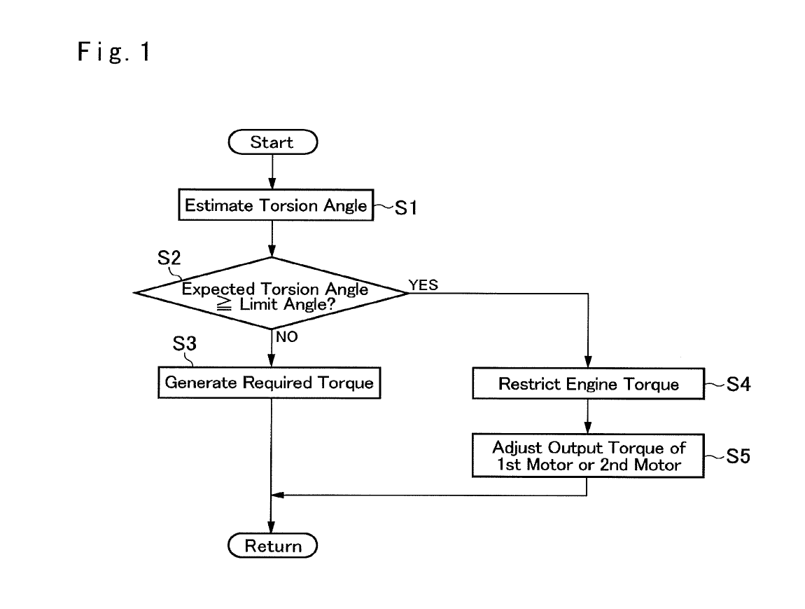

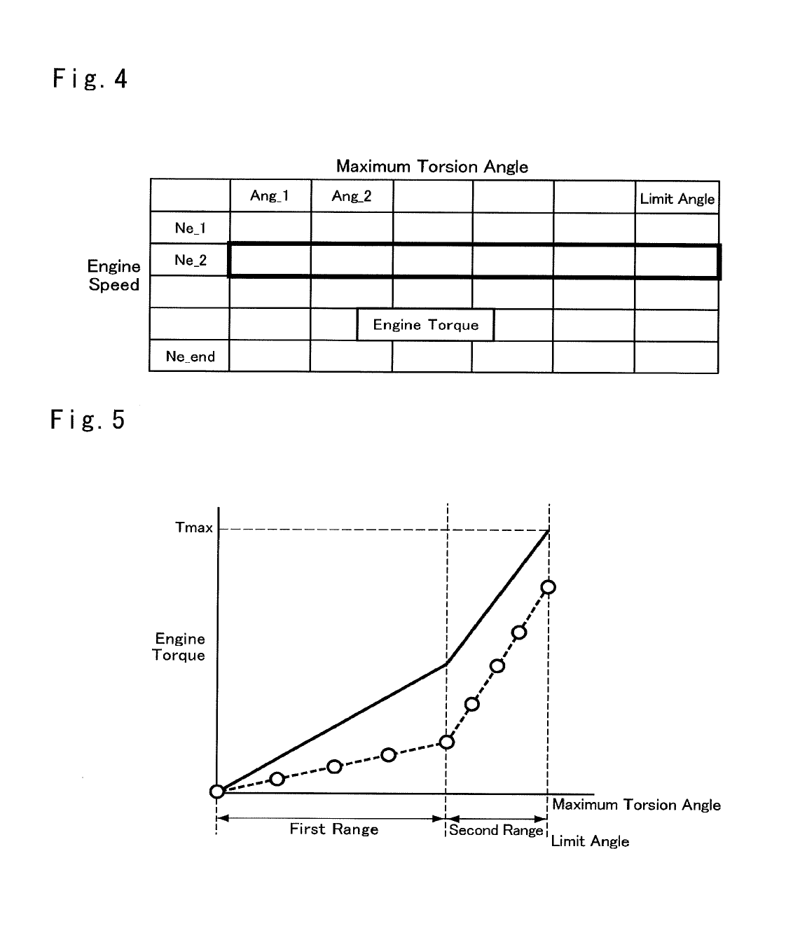

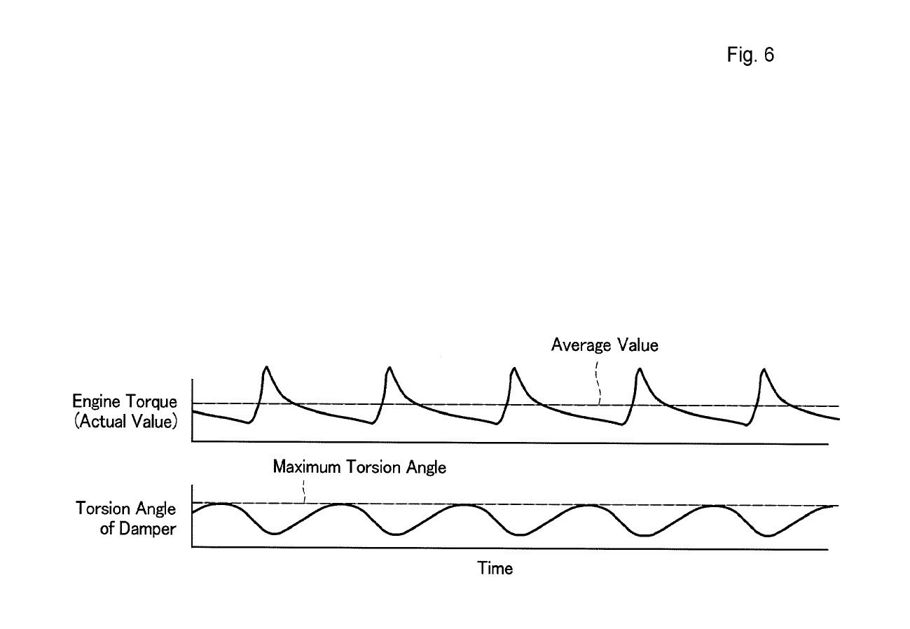

Here will be explained a control example for preventing application of an excessive torque to the spring damper 7 while achieving a required torque with reference to FIG. 1. First of all, a torsion angle between the input member I and the center plate 11 to be expected by applying a power of the engine 2 to the spring damper 7 while controlling the engine 2 in such a manner as to achieve a required drive force is estimated at step S1. To this end, a relation among a speed of the engine 2, an output torque of the engine 2 and a maximum torsion angle as a maximum phase difference between the input member I and the center plate 11 with respect to an input torque to the spring damper 7 is installed in the ECU 32 in the form of a map shown in FIG. 4, and the estimation of such relative movement at step S1 is made with reference to the map.

Specifically, the map shown in FIG. 4 may be prepared based not only on data collected in a factory but also on designed value. The torsion angle between the input member I and the center plate 11 is changed depending on an input torque to the spring damper 7, and whereas vibration frequency is changed depending on and engine speed thereby changing frequency of twisting motion of the spring damper 7. In the map shown in FIG. 4, therefore, the engine speed is employed as a parameter.

Specifically, the engine torque employed in the map shown in FIG. 4 is an average value of an output torque fluctuated by combustions of the engine 2 within a predetermined period of time, and the maximum torsion angle employed in the map shown in FIG. 4 is a maximum torsion angle between the input member I and the center plate 11 of a case in which the above-explained output torque of the engine 2 is applied to the spring damper 7.

Turning to FIG. 5, there is shown a map determining a relation between the engine torque indicated on a vertical axis and the torsion angle indicated on a horizontal axis. In FIG. 5, each point individually corresponds to a value of the maximum torsion angle determined in the map shown in FIG. 4. In FIG. 5, specifically, only the coil spring 13 is compressed in the spring holder in a first range, and the cushion 14 is also compressed together with the coil spring 13 in a second range. In the first range, therefore, an increasing rate of the maximum torsion angle with respect to an increase in the engine torque is less than that in a second range. In FIGS. 4 and 5, “Limit Angle” is a first predetermined value at which one of width the ends of the protrusion of the center plate 11 almost comes into contact with one of width ends of the protrusion of the stopper plate 15. Whereas, “Tmax” in FIG. 5 represents a limit torque by which the torsion angle between the input member I and the center plate 11 is increased to the limit angle.

Turning back to FIG. 1, after thus estimating the expected torsion angle at step S1, the expected torsion angle is compared to the limit angle at step S2 to predict that the limit torque is applied to the input member I. The routine shown in FIG. 1 is executed to prevent a collision of the center plate 11 with the stopper plate 15 when the torsion angle between the input member I and the center plate 11 is increased to the limit angle. That is, at step S2, a possibility of occurrence of such collision during controlling the engine 2 by the conventional way.

If the expected torsion angle is smaller than the limit angle so that the answer of step S2 is NO, the routine progresses to step S3 to control the engine 2 in such a manner as to generate a torque to achieve the required drive force, and then the routine is returned.

By contrast, if the expected torsion angle is equal to or greater than the limit angle so that the answer of step S2 is YES, the routine progresses to step S4 to restrict an output torque of the engine 2 thereby restricting the torsion angle between the input member I and the center plate 11 of the spring damper 7 within the limit angle. A limit value of the output torque of the engine 2 of this case may be determined with reference to the maps shown in FIGS. 4 and 5 in such a manner that the output torque of the engine 2 is restricted within the limit torque Tmax.

If the output torque of the engine 2 is thus restricted, the drive force required by the driver may not be achieved. In this case, therefore, the routine progresses to step S5 to adjust an output torque of any one of the first motor 3 and the second motor 4 in such a manner as to compensate a reduction in the drive force resulting from such restriction of the output torque of the engine 2, and then returned. Specifically, a speed of the engine 2 may be adjusted to a target speed not only by operating the first motor 3 as a motor while operating the second motor 4 as a generator, but also by operating the first motor 3 as a generator while operating the second motor 4 as a motor. At step S5, therefore, the reduction in the output torque of the engine 2 may be compensated not only by increasing an output torque of any of the motors 3 and 4 being operated as a motor but also by reducing an output torque of any of the motors 3 and 4 being operated as a generator.

By thus restricting the input torque to the spring damper 7, the torsion angle between the input member I and the center plate 11 of the spring damper 7 can be restricted within the limit angle to suppress noise resulting from collision of the center plate 11 with the stopper plate 15. In other words, the coil spring 13 and the cushion 14 can be prevented from being compressed excessively to ensure elasticities thereof to absorb vibrations. In addition, although the output torque of the engine 2 is restricted, a required drive force can still be achieved by adjusting the output torque of any one of the first motor 3 and the second motor 4.

The above-explained relation between the engine torque and the maximum torsion angle may be changed with time due to fatigue of the coil spring 13 or the like. Therefore, it is preferable to update the data employed in the maps shown in FIGS. 4 and 5 by estimating current condition of the spring damper 7 such as a change in the torsion angle with respect to a predetermined input torque, based on speeds of the output shaft 5 of the engine 2 and the output shaft 12 of the spring damper 7.

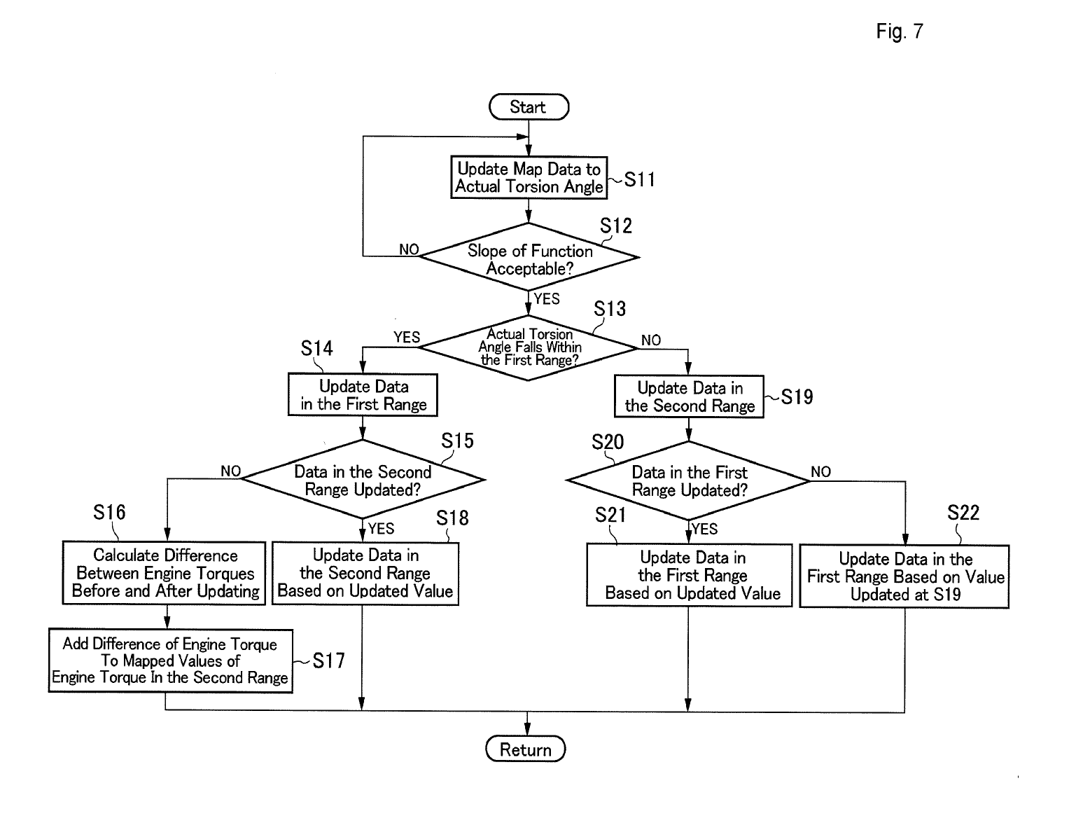

Turning to FIG. 7, there is shown a procedure of updating the mapped value of the output torque of the engine 2 with respect to an updated mapped value of the torsion angle between the input member I and the center plate 11 of the spring damper 7. The routine shown in FIG. 7 may be carried out simultaneously with the routine shown in FIG. 1. First of all, at step S11, a current maximum torsion angle between the input member I and the center plate 11 is obtained with respect to a current speed and a current output torque of the engine 2, and the mapped value of the maximum torsion angle with respect to the current speed and the current output torque of the engine 2 is updated to the current maximum torsion angle (i.e., an actual torsion angle) thus detected. To this end, for example, a rotational speed of the output shaft 5 of the engine 2 is detected by the first speed sensor 33 and a rotational speed of the output shaft 12 of the spring damper 7 is detected by the second speed sensor 34, and a speed difference between the output shaft 5 and the output shaft 12 is used to obtain the actual torsion angle. In order to obtain the actual torsion angle more accurately, phase angle sensors may also be used to detect phase angles of the output shaft 5 and the output shaft 12.

In order to obtain the actual torsion angle, a command value of a torque command to the engine 2, a detection value of the current output torque of the engine 2 detected by a sensor, an estimated value of the current output torque of the engine 2 estimated based on a fuel injection and an air intake and so on may be used.

According to the embodiment, the remaining mapped values of the output torque of the engine 2 with respect to the maximum torsion angle in the range where the actual maximum torsion angle has not yet been detected are determined based on the current actual torsion angle thus detected. However, detection values of the above-mentioned phase angle sensors or the like may contain detection error. That is, if the detected current actual torsion angle is small and a slope of the function shown in FIG. 5 is determined based on the detected small actual torsion angle that contains a detection error of the sensor, a divergence between the mapped value and the actual value of the output torque of the engine 2 with respect to the maximum torsion angle would be increased in the rage where the maximum torsion angle is large.

In the routine shown in FIG. 7, therefore, it is determined at step S12 whether or not a change in the slope of the function of the map shown in FIG. 5 due to detection error of the sensor is smaller than a predetermined value. Specifically, such determination of step S12 may be made by determining whether or not the current torsion angle that determines the slope of the function is larger than a second predetermined value that is smaller than an angle at which the cushion 14 starts to be compressed. Such update of the actual torsion angle at step S11 may be repeated to determine the slope of the function more accurately based on a plurality of data about the actual torsion angle.

If the current actual torsion angle is smaller than the second predetermined value so that the answer of step S12 is NO, the routine is returned to step S11 to repeat update of the mapped value of the torsion angle.

By contrast, if the current actual torsion angle is larger than the second predetermined value so that the answer of step S12 is YES, the routine progresses to step S13 to determine whether or not the current actual torsion angle falls within the first range where only the coil spring 13 is compressed. Specifically, such determination of step S13 may be made by comparing the current actual torsion angle with the angle at which the cushion 14 starts to be compressed that is determined by structures of the coil spring 13 and the cushion 14.

If the current actual torsion angle falls within the first range so that the answer of step S13 is YES, the routine progresses to step S14 to update the mapped values of the output torque of the engine 2 with respect to the maximum torsion angles in the remaining area of the first range. To this end, specifically, a deviation between the current actual torsion angle and the mapped value of the torsion angle at zero of the function shown in FIG. 5 is calculated. Then, a coefficient of the function extending from zero point is calculated by dividing the calculated deviation by the current actual torsion angle. The factor thus determined corresponds to the claimed “second coefficient”. Here, in FIG. 5, the solid line represents the function after updating the mapped value of the maximum torsion angle, and the dashed line represents the function before updating the mapped value of the maximum torsion angle.

After thus determining the coefficient of the linear function shown in FIG. 5, each mapped value of the maximum torsion angle within the first range except for the updated current actual torsion angle is individually multiplied by the above-mentioned coefficient to obtain the output torque of the engine 2 with respect to each mapped values of the maximum torsion angle. In a case that the update of the current actual torsion angle at step S11 is repeated, an approximate function is determined based on the collected data about the actual torsion angles, and each mapped value of the maximum torsion angle within the first range except for the updated current actual torsion angle is individually multiplied by a coefficient of the approximate function to obtain the output torque of the engine 2 with respect to each mapped value of the maximum torsion angle. Accordingly, the coefficient of the approximate function corresponds to the claimed “first coefficient”.

Then, it is determined at step S15 whether or not the mapped value of the maximum torsion angle in the second range has been updated. Such determination at step S15 may be made by a similar procedure as step S13. Specifically, the determination at step S15 may be made by comparing the current actual torsion angle with the angle at which the cushion 14 starts to be compressed.

If the mapped value of the maximum torsion angle in the second range has not yet been updated so that the answer of step S15 is NO, the routine progresses to step S16 to calculate a difference between the value of the output torque of the engine 2 with respect to the torsion angle at the border between the first range and the second range updated at step S14, and a prior value of the output torque of the engine 2 with respect to the torsion angle at the border between the first range and the second range. Thereafter, at step S17, the calculated difference is individually added to the remaining mapped values of the output torque of the engine 2 in the second range. Consequently, the function in the second range is shifted upwardly based on the current maximum torsion angle updated at step S11 without changing the slope, and then the routine is returned.

By contrast, if the mapped value of the maximum torsion angle in the second range has been updated so that the answer of step S15 is YES, the routine progresses to step S18 to update the mapped values of the output torque of the engine 2 with respect to the remaining mapped values of the maximum torsion angle in the second range based on the updated maximum torsion angle in the second range. Specifically, a linear function is determined in the map shown in FIG. 5 in such a manner as to pass through a point determined based on the output torque of the engine 2 updated at step S14 with respect to the torsion angle at the border between the first range and the second range, and a point determined based on the updated value of the maximum torsion angle in the second range and the output torque of the engine 2 with respect thereto. Then, the remaining mapped values of the maximum torsion angle in the second range are individually multiplied by a coefficient of the linear function to update the mapped values of the output torque of the engine 2 with respect to the updated mapped values of the maximum torsion angle in the second range, and the routine is returned. The coefficient of the linear function thus determined also corresponds to the claimed second coefficient.

Turning back to step S13, if the current actual torsion angle falls within the second range so that the answer of step S13 is NO, the routine progresses to step S19 to update the mapped values of the output torque of the engine 2 with respect to the maximum torsion angles in the remaining area of the second range. To this end, specifically, a new function is determined in the second range in such a manner as to pass through a point determined based on the current actual torsion angle and the output torque of the engine 2 with respect thereto with a same slope as the previous function. Then, the remaining mapped values of the maximum torsion angle in the second range are individually multiplied by a coefficient of the new function to update the mapped values of the output torque of the engine 2 with respect to the updated mapped values of the maximum torsion angle in the second range. The coefficient of the new function thus determined also corresponds to the claimed second coefficient.

Then, it is determined at step S20 whether or not the mapped value of the maximum torsion angle in the first range has been updated. Such determination at step S20 may also be made by a similar procedure as step S13. Specifically, the determination at step S20 may be made by comparing the current actual torsion angle with the angle at which the cushion 14 starts to be compressed.

If the mapped value of the maximum torsion angle in the first range has been updated so that the answer of step S20 is YES, the routine progresses to step S21 to update the mapped values of the output torque of the engine 2 with respect to the remaining mapped values of the maximum torsion angle in the first range based on the updated maximum torsion angle in the first range. Specifically, a linear function is also determined in the map shown in FIG. 5 in such a manner as to pass through a point determined based on the updated torsion angle in the first range and the output torque of the engine 2 with respect thereto, and a point determined based on the torsion angle at the border between the first range and the second range updated at step S19 and the output torque of the engine 2 with respect thereto. Then, the remaining mapped values of the maximum torsion angle in the second range are individually multiplied by a coefficient of the linear function thus determined to update the mapped values of the output torque of the engine 2 with respect to the updated mapped values of the maximum torsion angle in the first range, and the routine is returned. The coefficient of the linear function thus determined also corresponds to the claimed second coefficient. If a plurality of actual torsion angles have been updated in the first range, an approximate function is determined based on the collected data about the actual torsion angles in the first range, and the output torque of the engine 2 with respect to the torsion angle at the border between the first range and the second range updated at step S19. Then, each mapped value of the maximum torsion angle within the first range except for the updated current actual torsion angle is individually multiplied by a coefficient of the approximate function to obtain the output torque of the engine 2 with respect to each mapped value of the maximum torsion angle. Accordingly, the coefficient of the approximate function also corresponds to the claimed first coefficient. Then, the routine is returned.

By contrast, if the mapped value of the maximum torsion angle in the first range has not yet been updated so that the answer of step S20 is NO, the routine progresses to step S22 to determine a linear function in such a manner as to pass through the zero point and a point determined based on the torsion angle at the border between the first range and the second range updated at step S19 and the output torque of the engine 2 with respect thereto. Then, each mapped value of the maximum torsion angle within the first range is individually multiplied by a coefficient of the linear function thus determined to obtain the output torque of the engine 2 with respect to each mapped value of the maximum torsion angle, and the routine is returned.

After thus updating the maps shown in FIGS. 4 and 5, the routine shown in FIG. 1 is executed while with reference to the updated maps shown in FIGS. 4 and 5.

By thus updating the maps shown in FIGS. 4 and 5 based on the current maximum torsion angle between the input member I and the center plate 11 of the spring damper 7, behavior of the spring damper 7 can be comprehended accurately even if a relation between the output torque of the engine 2 and the torsion angle of the spring damper 7 is changed due to time degradation of the coil spring 13. For this reason, a collision of the center plate 11 with the stopper plate 15 can be prevented certainly. In addition, since the relation between the output torque of the engine 2 and the torsion angle of the spring damper 7 is thus updated based on the actual torsion angle, a collision of the center plate 11 with the stopper plate 15 can be prevented even if the engine is operated at an operating point where the output torque and the speed of the engine cannot be detected by the sensor.

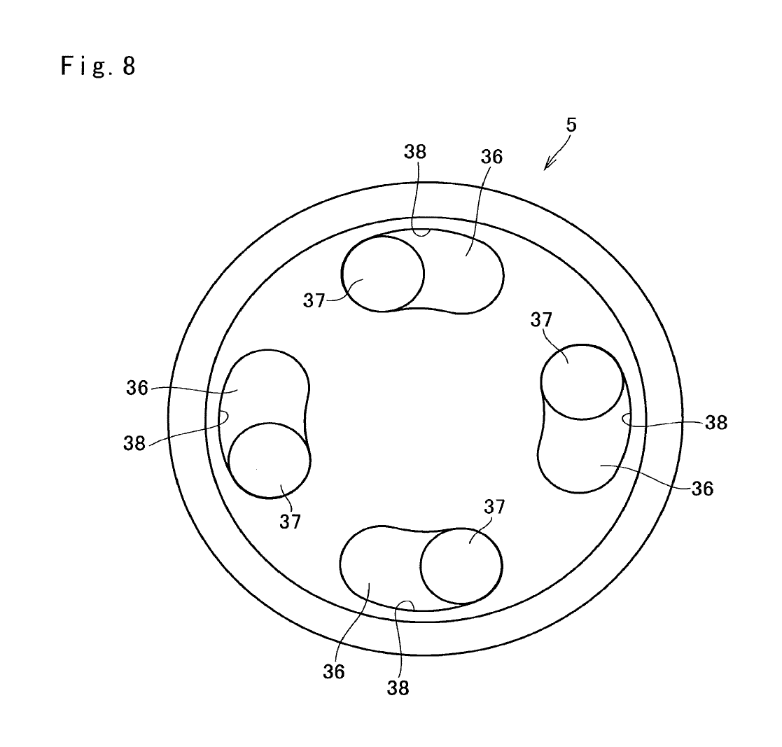

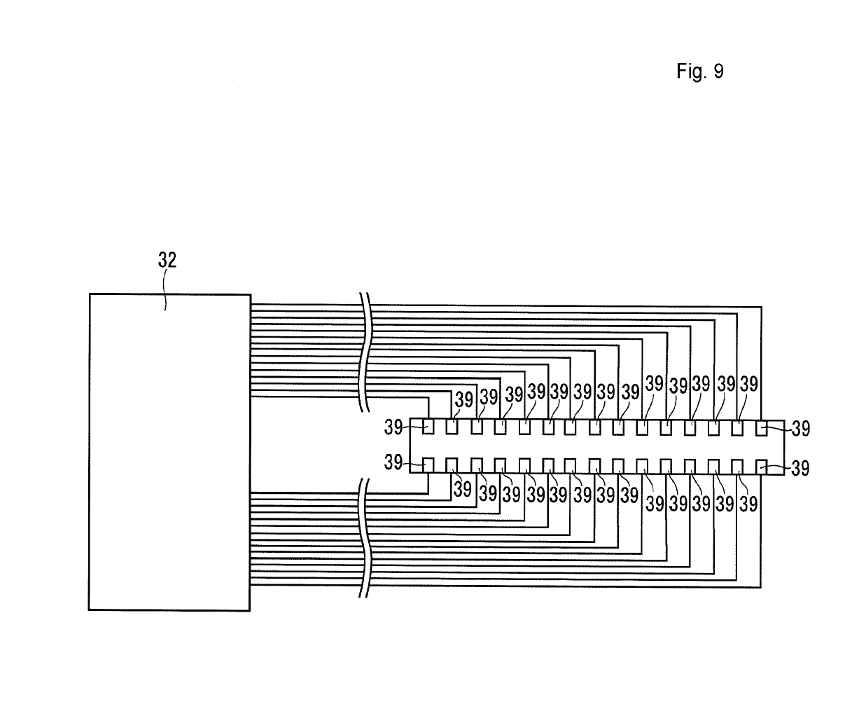

The routines shown in FIGS. 1 and 7 may also be executed to suppress noise of a dynamic damper shown in FIG. 8. In the dynamic damper shown in FIG. 8, holding chambers 36 each of which has a predetermined length in a circumferential direction are formed on an end face of the output shaft 5 in a circular manner at regular intervals, and a rolling mass 37 is individually held in each of the holding chamber 36 while being allowed to oscillate therein. A curvature radius of a raceway surface 38 is adjusted in a manner such that number of oscillation per rotation of the rolling mass 37 is adjusted to number of pulsations per rotation exerted on the output shaft 5 of the engine 2. As illustrated in FIG. 9, in order to detect amplitude of oscillation of the rolling mass 37 or phase of the rolling mass 37, a plurality of sensors 39 are arranged on the raceway surface 38 in a circumferential direction at regular intervals while being connected to the ECU 32. Specifically, each of the sensors 39 is energized when the rolling mass 37 rolls thereon to send a detection signal to the ECU 32.

In order to execute the routines shown in FIGS. 1 and 7 to suppress noise of a dynamic damper shown in FIG. 8, amplitude of oscillation of the rolling mass 37 is employed in the map shown in FIG. 4 instead of the torsion angle. In this case, in the routine shown in FIG. 1, amplitude of oscillation of the rolling mass 37 is estimated at step S1, and the estimated amplitude of oscillation of the rolling mass 37 is compared to a limit amplitude at step S2. Whereas, in the routine shown in FIG. 7, the output torque of the engine 2 is updated based on the current actual amplitude of oscillation of the rolling mass 37.

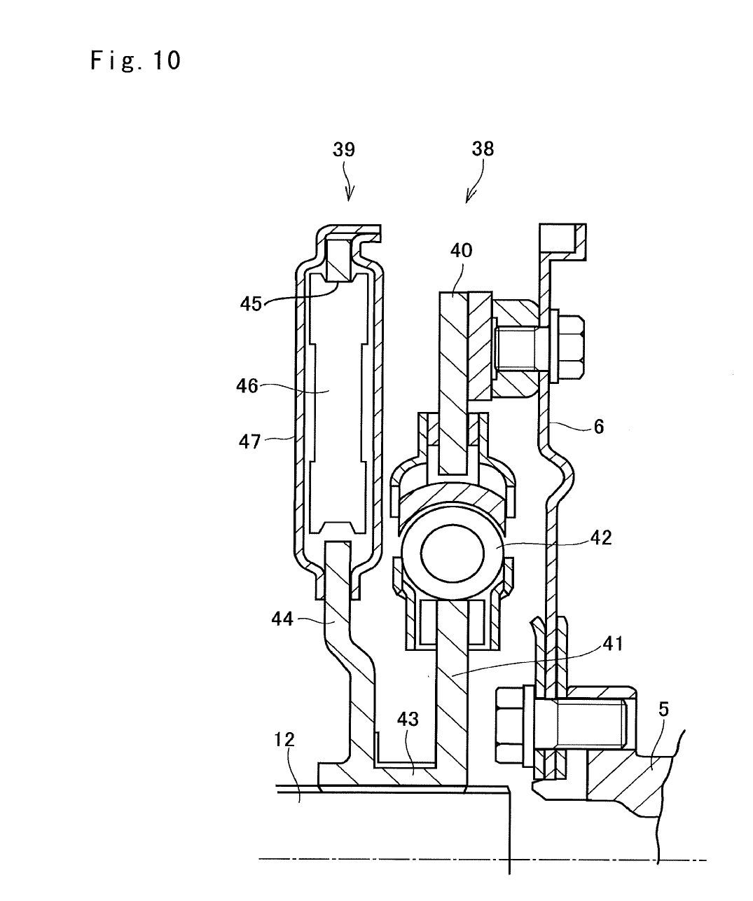

Turning to FIG. 10, there is shown another example of the torsional damper to which the control system of the embodiment is applied. According to another example, a spring damper 38 is connected to a dynamic damper 39 to form a torsional damper. Specifically, the spring damper 38 comprises an annular outer plate 40 as an input member to which torque of the engine 2 is applied, an inner plate 41 as a relative member splined onto the output shaft 12 while being allowed to rotate relatively to the outer plate 40, and a coil spring 42 that elastically transmits torque from the outer plate 40 to the inner plate 41. Specifically, the coil spring 42 is interposed between an inner circumferential face of the outer plate 40 and an outer circumferential face of the inner plate 41. In the spring damper 38, therefore, the coil spring 42 is compressed by a relative rotation between the outer plate 40 and the inner plate 41 to absorb pulsation of the torque transmitted from the outer plate 40 to the inner plate 41.

An inner circumferential end of annular rotary member 44 as an input member of the dynamic damper 39 is connected to an inner circumferential end of the inner plate 41 of the spring damper 38 through a cylinder 43. A plurality of holding chambers 45 are formed on the rotary member 44 in a circular manner at regular intervals, and a rolling mass 46 as a relative member is individually held in each of the holding chamber 45 while being allowed to oscillate therein. Each of the holding chambers 45 is individually covered by a cover 47. In the dynamic damper 39, therefore, torque of the engine 2 is applied to the rotary member 44 through the spring damper 38, and the rolling mass 46 is oscillated by the torque pulse.

Thus, the output torque of the engine 2 is applied to the dynamic damper 39 through the spring damper 38. In the torsional damper shown in FIG. 10, although width of the torque pulse applied to the dynamic damper 39 is suppressed, amplitude of the torque (i.e., an average torque) applied to the dynamic damper 39 is substantially identical to the output torque of the engine 2. In this case, maps shown in FIGS. 4 and 5 are prepared for each of the spring damper 38 and the dynamic damper 39. In this case, in the routine shown in FIG. 1, a torsion angle of the spring damper 38 and amplitude of oscillation of the rolling mass 46 are estimated at step S1 with reference to the maps, and at least one of the torsion angle of the spring damper 38 and amplitude of oscillation of the rolling mass 46 is compared to the limit angle and the limit amplitude. If the answer of step S2 is NO, the output torque of the engine 2 is restricted at step S4 to be lower than the limit torque determined in the maps. By thus carrying out the routine shown in FIG. 1, a relative movement between the input member (i.e., the outer plate 40 or the rotary member 44) and the rotary member (i.e., the inner plate 41 or the rolling mass 46) can be restricted to suppress noise without reducing the drive force. In this case, the map shown in FIG. 7 is also prepared for each of the spring damper 38 and the dynamic damper 39.

Although the above exemplary embodiments of the present invention have been described, it will be understood by those skilled in the art that the present invention should not be limited to the described exemplary embodiments, but that various changes and modifications can be made within the spirit and scope of the present invention. For example, the number of the motor and a structure of the powertrain are not limited to those shown in FIG. 2.

What is claimed is:

1. A control system for a hybrid vehicle, comprising:
an engine;
a torsional damper in which an input member and a relative member are moved relatively to each other in a rotational direction by a pulsation of a torque of the engine applied to the input member;
a motor that is disposed on a power train between the torsional damper and drive wheels; and
a controller for controlling the engine and the motor that is configured to:
predict that a limit torque by which a relative movement of the relative member to the input member is increased to be equal to or greater than a first predetermined value is applied to the input member; and
restrict the torque of the engine to be lower than the limit torque while adjusting an output torque of the motor to compensate a reduction in a drive force resulting from a restriction of the torque of the engine, in a case that an application of the limit torque to the input member is expected.

2. The control system for a hybrid vehicle as claimed in claim 1,
wherein a map determining the relative movement with respect to the torque applied to the input member is installed into the controller, and
wherein the controller is further configured to estimate the relative movement with respect to the torque applied to the input member with reference to the map.

3. The control system for a hybrid vehicle as claimed in claim 2, wherein the controller is further configured to:
obtain an actual torque applied to the input member and an actual relative movement of the relative member of a case in which the actual torque is applied to the input member; and
update the map based on the actual torque and the actual relative movement.

4. The control system for a hybrid vehicle as claimed in claim 3, wherein the controller is further configured to:
calculate a difference between the actual torque and a torque applied to the input member determined by the map; and
update the map by adding the calculated difference to each value of the torque applied to the input member determined by the map.

5. The control system for a hybrid vehicle as claimed in claim 3, wherein the controller is further configured to:
calculate a first coefficient of a function defining a relation between the torque and the relative movement based on the actual torque and the actual relative movement; and
update each value of the torque applied to the input member determined in the map by multiplying each value of the relative movement determined by the map individually by the first coefficient.

6. The control system for a hybrid vehicle as claimed in claim 3, wherein the controller is further configured to:
calculate a deviation from a reference value of the relative movement in which the torque is not applied to the input member to the actual relative movement;
calculate a second coefficient of a function defining a relation between the torque and the relative movement based on the actual torque and the actual relative movement; and
update each value of the torque applied to the input member determined by the map, by multiplying each value of the relative movement determined by the map individually by the second coefficient.

7. The control system for a hybrid vehicle as claimed in claim 3, wherein the controller is further configured to update the map in a case that the actual relative movement is greater than a second predetermined value.

8. The control system for a hybrid vehicle as claimed in claim 2, wherein the controller is further configured to restrict the torque of the engine in such a manner that the relative movement determined by the map is reduced to be smaller than the first predetermined value.

9. The control system for a hybrid vehicle as claimed in claim 1,
wherein the relative member includes an output member that is connected to the drive wheels while being allowed to rotate relatively to the input member,
wherein the torsional damper comprises the input member, the output member, and an elastic member that is elastically deformed by a relative rotation between the input member and the output member, and
wherein the relative movement includes a phase difference between the input member and the output member.

10. The control system for a hybrid vehicle as claimed in claim 1,
wherein the input member comprises a holding chamber having a predetermined length in a circumferential direction,
wherein the relative member includes a rolling mass that is held in the holding chamber while being allowed to be oscillated therein by pulsation of the torque applied to the input member, and
wherein the relative rotation includes at least one of an amplitude of oscillation of the rolling mass and a phase of the rolling mass.
